(19) United States
(12) Patent Application Publication
(10) Pub. No.: US 2026/0243235 A1
(43) Pub. Date: Aug. 20, 2026

(54) Device for exchanging geothermal energy with an aquifer which is near the surface, and thermal power station comprising at least one such device

(71) Applicant: USC-CONSULTING GMBH, Hessisch Lichtenau (DE)

(72) Inventor: Uwe SCHINDLER, Hessisch Lichtenau (DE)

(73) Assignee: USC-CONSULTING GMBH, Hessisch Lichtenau (DE)

(21) Appl. No.: 19/156,276

(22) PCT Filed: Mar. 20, 2024
(86) PCT No.: PCT/EP2024/057424

§ 371 Date: Aug. 13, 2025

(30) Foreign Application Priority Data
Mar. 23, 2023 (DE) 102023107286.2

(51) Int. Cl. F03G 4/00

(52) U.S. Cl. CPC F03G 4/026; F03G 4/001; F03G 4/045; F05B 2260/63

(57) ABSTRACT

The invention relates to a device for exchanging geothermal energy with a near-surface aquifer for operation in a thermal power station with an extraction well (1) for extracting groundwater from the aquifer (3) through at least one extraction line (7) and with an injection well (4) for injecting the extracted groundwater into the aquifer (3) through at least one injection line (9), wherein the at least one extraction line (7) is connected to the at least one injection line (9) for forwarding water via a primary line (17). The invention is characterised in that the extraction well (1) has at least one horizontal extraction string (6) at its aquifer-side end (12), wherein this at least one extraction string (6) is operatively connected to at least one extraction line (7) for conveying water out of the aquifer (3) and wherein a filter line (2) is arranged within the at least one extraction string (6).

The invention relates to a device according to the preamble of claim 1 and a thermal power station with at least one such geothermal doublet.

Near-surface geothermal energy is understood to mean the utilisation of geothermal energy from depths of up to 400 metres. A geothermal doublet consists of an extraction well for extracting groundwater and an injection well for returning the cooled water from an aquifer close to the surface. A geothermal doublet is the central element of a geothermal system, whereby the number of extraction wells does not necessarily have to be the same as the number of injection wells for returning the groundwater. In a geothermal doublet, groundwater is pumped from groundwater-bearing rock layers, so-called near-surface aquifers, from which heat is extracted in a thermal power plant via a heat exchanger and/or a heat pump. For reasons of water balance and water equilibrium within the aquifer, it is then planned to return the water extracted via the extraction well to the same aquifer at a certain distance from the extraction well via an injection well.

In principle, a large number of devices according to the generic term of claim 1 are already known. For example, DE 10 2016 002 255 A1 describes how water is pumped from a shaft of a flooded underground mine in order to utilise the geothermal energy stored therein, how some of the geothermal energy is extracted from the water via a heat exchanger and how the water is then fed back into the flooded underground mine via another shaft.

Further devices according to the generic term of claim 1 are also known from DE 10 2008 057 943 A1, DE 10 2015 002 744 B4, CH 703 613 A1 and DE 103 43 544 A1.

Usually, a geothermal doublet therefore consists of two vertical boreholes at corresponding distances, with one being used as an extraction well and the other as an injection well. As an aquifer can be used to a maximum depth of 400 metres in near-surface geothermal or closed systems, a vertical well can extract water from the aquifer to a maximum depth of 400 metres, with the effective extraction area corresponding to the height of the aquifer, usually several tens of metres. An extension can be achieved by drilling several vertical extraction wells. However, this type of upscaling requires more space on the surface, meaning that the area required for this cannot be used for other purposes. It is possible to drill production and injection wells from one drilling site, whereby a larger user horizon can be developed through deviated wells. However, further upscaling of vertical wells drilled in this way also requires more space due to additional vertical wells on the surface, meaning that the space required for upscaling cannot be utilised for other purposes in this case either. In addition, the increase in capacity due to an additional borehole is only a factor of 2 compared to the original borehole.

It is therefore the task of the invention to provide a device according to the preamble of claim 1, with which upscaling is possible without requiring additional surface area. Furthermore, it is the task of the invention to provide a thermal power station with such a device.

With regard to the device, this task is solved by a device with all the features of claim 1. With regard to the thermal power station, this task is solved by a thermal power station with all the features of claim 12. Advantageous embodiments of the invention can be found in the sub-claims.

The device according to the invention for exchanging geothermal energy or thermal energy with a near-surface aquifer for operation in a thermal power plant has an extraction well for extracting groundwater from a near-surface aquifer and an injection well for returning or injecting the extracted groundwater back into the near-surface aquifer. The at least one extraction line is connected to the at least one injection line for forwarding the water via a primary line. In accordance with the invention, it is now provided that the extraction well has at least one horizontal extraction string at its aquifer-side end, wherein the extraction strings are in operative connection with at least one extraction line for conveying water out of the aquifer and wherein a filter line is arranged within each extraction string. In practice, the extraction well will be designed as a vertical shaft, which usually has a fixed shaft bottom. Within this shaft, a horizontal extraction string or several horizontal extraction strings can now be introduced into the aquifer for pumping the groundwater. It is essential to the invention that even one horizontal extraction string is sufficient to increase the capacity of the extraction well by an order of magnitude, i.e. by a factor of 10 or even more, compared to a vertical well according to the state of the art. The decisive factor here is that the at least one extraction string can be driven more than 100 metres into the aquifer and groundwater can be extracted from these more than 100 metres. The greater the number of extraction strings, the greater the capacity of the entire device and thus the greater the amount of heat that can be extracted from or supplied to the groundwater in a thermal power plant. In addition to the one vertical shaft, no additional vertical borehole is required for this, so that no additional surface area is needed when upscaling the system. The horizontal extraction strings located on one or more levels are also referred to as horizontal wells in their entirety.

The individual extraction strings within the shaft can be designed as either wet or dry wells, In a wet installation, the groundwater conveyed via the extraction strings is collected at the bottom of the shaft and conveyed to the surface via at least one extraction line. However, the groundwater collected at the bottom of the shaft comes into contact with the oxygen and other gases contained in the air, so that the probability of clogging within the at least one extraction line can increase with the service life, depending on the mineralisation of the groundwater.

The device according to the invention is advantageously suitable for extracting geothermal energy from an aquifer in order to supply heat customers, such as private households, but also commercial and industrial plants, with heat. On the other hand, it is also possible to use the device according to the invention for cooling. In turn, both private households and commercial and industrial plants, such as energy-intensive data centres or the like, can be cooled.

According to a first advantageous embodiment of the invention, it is provided that the injection well has at least one horizontal injection string at its aquifer-side end, wherein the at least one injection string is in operative connection with at least one injection line for introducing water into the aquifer and wherein a filter line is arranged within the at least one injection string. According to this embodiment of the invention, the injection well has an identical configuration to the extraction well, i.e. it is mirrored. This is particularly advantageous because the injection well has at least the same capacity for water to be introduced as the extraction well for water to be pumped. Advantageously, however, the injection well has a larger capacity so that the introduction of the water extracted from the aquifer is ensured in any case. A separate capacity adjustment is therefore not necessary. In this embodiment of the invention, it is then also envisaged that the injection well is not designed as a simple vertical well. Rather, this injection well is then also designed as a vertical injection shaft, in which at least one horizontal injection string returns the groundwater to the aquifer. In this respect, the injection well also has a horizontal well-equivalent to the extraction well—in which, however, the groundwater is returned via the at least one injection string. In this embodiment of the invention, it can also be provided that the injection strings of the injection well within the injection shaft return the groundwater to the same aquifer at different heights. This measure also increases the absorption capacity of the injection well, so that no further injection well needs to be drilled at the surface during upscaling, which also minimises the area required for the injection well at the surface, so that the area saved is available for other purposes.

In this case, both the extraction well with the at least one extraction line and the at least one extraction string form a first separate horizontal filter well and the injection well with the at least one injection line and the at least one injection string form a second separate horizontal filter well. These two separate horizontal filter wells form a geothermal doublet. Both the extraction well and the injection well can be designed as a shaft.

According to a further advantageous embodiment of the invention, however, it is envisaged that the groundwater extracted from the aquifer through the one horizontal well or through the extraction well is conveyed to the injection well with the exclusion of external oxygen. A dry installation is preferably realised here, in which the groundwater pumped via each horizontal extraction string is pumped directly to the injection well by means of a line system with the exclusion of external oxygen. The advantage of the dry installation is that the entire extraction and return process of the groundwater can be carried out without external oxygen, which significantly minimises the problem of clogging within the line system and therefore significantly increases the service life of the line system.

In an advantageous embodiment of the invention, the individual extraction strings are combined in a common extraction line, in which the extracted groundwater is conveyed to the surface and on to the injection well.

In order to enable the entire geothermal doublet to be upscaled again, according to a particularly advantageous embodiment of the invention, at least one horizontal extraction string is provided at different heights of the extraction well or extraction shaft within the aquifer. With this embodiment of the invention, groundwater is extracted from different levels, i.e. different heights of the aquifer, and the amount of groundwater extracted is further increased without increasing the surface area required. In this respect, this measure also further increases the amount of heat that can be extracted from the geothermal doublet in a thermal power station without having to provide additional surface area. The extracted groundwater is fed back into the same aquifer via the injection well, so that the groundwater table and thus the water balance remain unaffected and in sum, no groundwater is extracted from the aquifer.

According to a further embodiment of the invention, it is provided that the extraction well or the extraction shaft and the injection well have a minimum distance of ten times the depth of the extraction well and the injection well from each other. This measure ensures that the groundwater returned via the injection well has the opportunity to reabsorb the amount of heat extracted from the geothermal energy by the thermal power station in the aquifer before it reaches the extraction well again and can be fed back to the thermal power station for renewed heat extraction. This effectively prevents the aquifer from cooling down. In order to enable efficient heat extraction without generating cooling of the entire aquifer over a longer period of time, the minimum distance between the production and injection well or shaft must be determined using a calculation model adapted to the geology of the aquifer site. If the distance is sufficient, the geothermal energy will supply the aquifer with enough heat energy to effectively prevent the aquifer from cooling down.

In principle, it can be provided that the number of horizontal injection strings within the injection well or the vertical injection shaft corresponds to the number of horizontal extraction strings of the horizontal well or wells of the extraction well, so that the extraction and absorption capacity is the same. However, it is advantageous if the number of horizontal injection strings within the injection well is greater than the number of horizontal extraction strings of the horizontal well or wells of the extraction well, as the return of the extracted groundwater can take place without additional pressure, so that the equipment costs are minimised by dispensing with pumps within the injection well.

According to another advantageous embodiment of the invention, the horizontal extraction strings and/or the horizontal injection strings have a length of more than 10 metres, preferably more than 50 metres and particularly preferably more than 100 metres. Upscaling can also be achieved by varying the length of the extraction strings, so that a larger amount of groundwater can be conveyed to the thermal power plant and a larger amount of heat can be extracted there without requiring additional surface area. The corresponding length of the injection strings, which must be able to absorb the returned groundwater, is aimed in the same direction. By varying the length of the individual extraction and injection strings, it is easy to adapt the geothermal doublet or the heat power plant to the heat customers. In principle, it is even possible to subsequently increase the capacity of the geothermal doublet or the thermal power station by introducing further horizontal delivery and injection strings.

According to a further idea of the invention, it is envisaged that the horizontal extraction strings and/or the horizontal injection strings are equipped with filter pipes. This makes it possible for the groundwater to penetrate into the filter pipes of the extraction strings and to emerge from the filter pipes of the injection strings, thus enabling simple and safe extraction and return of the groundwater.

In order to free the groundwater from possible larger particles, it is intended that the filter pipes are stored in a bed, with gravel or glass balls preferably being used as the bedding material and/or filter material. These materials are particularly well suited to retaining particles, whereby when glass balls are used, especially as filter material, they can be cleaned much more effectively than when gravel is used as filter material. In addition, the grain size of the gravel or the size of the glass balls is adapted to the flow velocity of the groundwater in the aquifer in order to enable particularly effective extraction and recirculation of the groundwater.

According to a further advantageous embodiment of the invention, it is provided that an overpressure is maintained by means of the extraction pumps within the device, in particular within the at least one extraction line and the at least one injection line, or that the water is pumped through the at least one extraction line and the at least one injection line at a pressure to be determined or adapted in order to avoid or minimise precipitation and ochre formation within the at least one extraction line and the at least one injection line.

The thermal power station according to the invention is equipped with at least one device as described above. A thermal power station of this type can extract or supply significantly more heat from the groundwater than when used with a geothermal doublet with a normal vertical well, so that significantly more consumers can draw thermal energy from the thermal power station or supply it to the thermal power station and thus significantly more households can be supplied with thermal energy or cooled in a residential area, for example, or significantly more thermal energy can be utilised for industrial purposes for both heating and cooling. Upscaling is also possible, as horizontal extraction strings can be introduced at different heights within the vertical extraction well or the extraction shaft within the horizontal well. In the same way, it is also possible to return the groundwater via the injection well with corresponding horizontal injection strings without increasing the area required on the surface.

It has also proved advantageous for the thermal power station to have at least one heat exchanger and/or at least one heat pump in order to extract or supply thermal energy to the groundwater extracted between the extraction well and the injection well. For this purpose, the extracted groundwater is supplied to the heat exchanger and/or the heat pump in a primary line, whereby a liquid is heated or cooled in a secondary line coupled to the heat exchanger and/or the heat pump and the supplied or extracted thermal energy is passed on to consumers via the secondary line. Therefore, the at least one heat exchanger and/or the at least one heat pump is operatively connected on the one hand to the primary line and on the other hand to a closed secondary line for transferring thermal energy, with the secondary line being operatively connected to consumers.

Since the utilisation of geothermal energy is a CO₂-free and regenerative energy utilisation, it is advisable to keep the entire energy utilisation process CO₂-free in order to make the operation of the geothermal doublet and the thermal power station as emission-free as possible. It therefore makes sense to use electricity generated from renewable sources, such as photovoltaic or wind power plants, to operate the heat pump.

By using geothermal doublets with horizontal wells, the capacity of the thermal power plant can be significantly increased, as significantly more groundwater can be extracted from the aquifer and returned than with vertical wells, so that significantly more groundwater can be made available to the thermal power plant, from which significantly more thermal energy can then also be extracted. The thermal power station can be easily adapted to requirements by varying the number of horizontal production and injection strings or by connecting additional geothermal doublets with horizontal wells to the thermal power station.

As already described, it is possible to run the entire process in opposite directions and use the geothermal doublet for both heating and cooling. For cooling, heat is extracted from the fluid in the secondary line in a heat exchanger and/or a heat pump and fed to the groundwater via the primary line, while for heating, thermal energy is fed from the primary line to the secondary line via a heat exchanger and/or a heat pump, which can then be used to supply heat to consumers.

Further objectives, advantages, features and possible applications of the present invention are apparent from the following description of the embodiments with reference to the drawings. All the features described and/or illustrated form the object of the present invention, either individually or in any meaningful combination, even independently of their summary in the claims or their relationship to one another.

It shows:

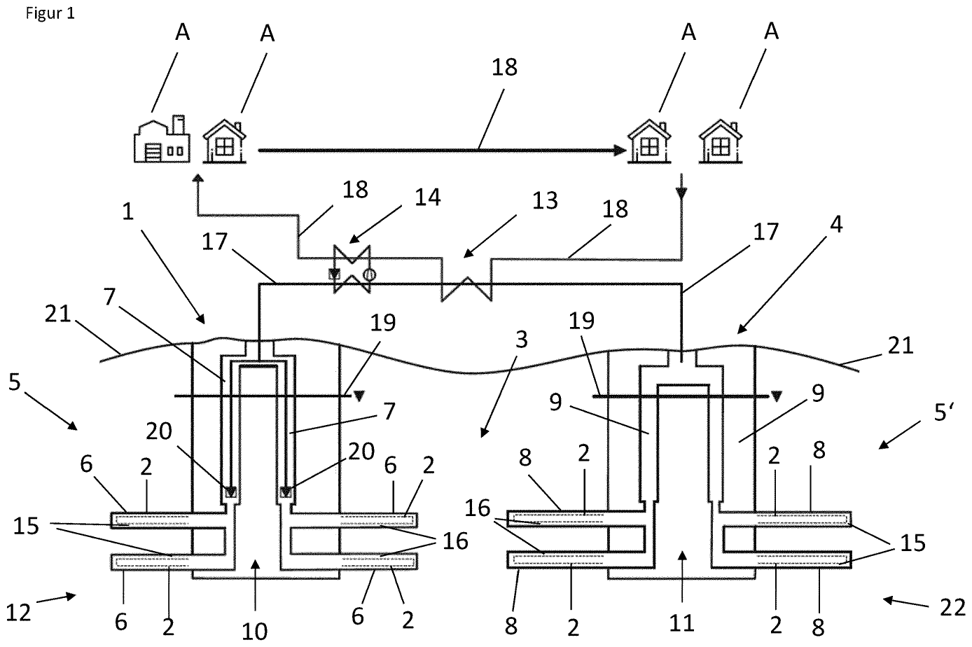

FIG. 1: a first embodiment example of a thermal power station according to the invention with a first embodiment example of a device according to the invention for operation in the thermal power station,

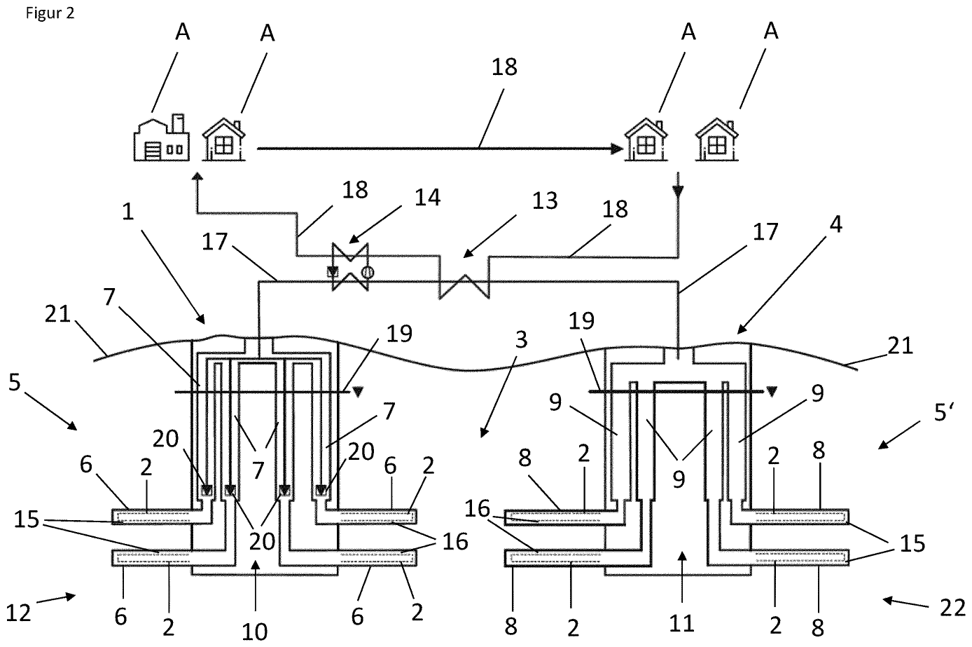

FIG. 2: a second embodiment example of a thermal power plant according to the invention with a second embodiment example of a device according to the invention for operation in the thermal power plant and

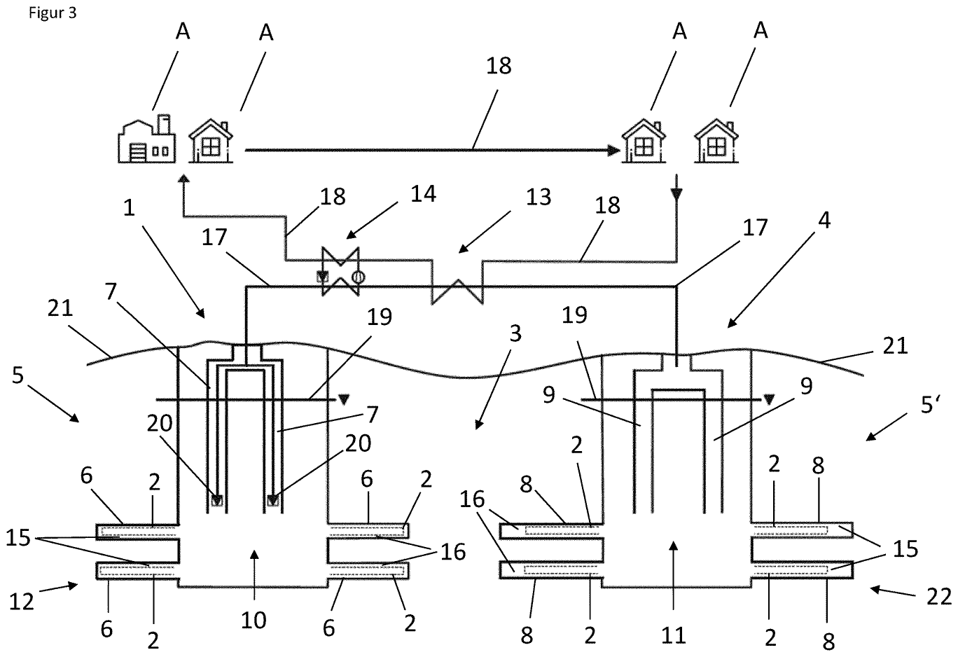

FIG. 3: a third embodiment example of a thermal power plant according to the invention with a third embodiment example of a device according to the invention for operation in the thermal power plant.

FIG. 1 shows a first embodiment example of a thermal power station according to the invention, in which a first embodiment example of a geothermal doublet according to the invention is used in a dry installation.

The heat power plant according to the invention of FIG. 1 essentially comprises a heat pump 14 and a heat exchanger 13, which supply a plurality of heat customers A with heat energy via a secondary line 18. Both the heat exchanger 13 and the heat pump 14 are coupled to a geothermal doublet via a primary line 17. The geothermal doublet has a delivery section and an injection section, which are connected to each other by means of the primary line 17, the primary line 17 being coupled to the thermal power station or the heat pump 14 and the heat exchanger 13 in such a way that the thermal energy of the groundwater pumped in the primary line is transferred to the thermal power station. The extraction section essentially consists of an extraction well 1, which in the present embodiment example is designed as an extraction shaft 10 arranged below the earth's surface 21. Two extraction lines 7 are arranged in the extraction shaft 10, each of which is connected on the one hand to two extraction strings 6 arranged at an aquifer-side end 12 of the extraction lines 7 and on the other hand to the primary line 17.

In the present embodiment example, two extraction strings 6 are arranged at two different heights in the extraction shaft 10, which project into an aquifer 3 and are designed to convey groundwater from the aquifer 3 via the extraction lines 7 to the primary line 17 in order to make thermal energy contained in the groundwater available to the heat power plant by means of the heat pump 14 and the heat exchanger 13. The extraction strings 6 form a horizontal well 5, so that a horizontal well 5 with extraction strings 6 arranged at different heights within the aquifer 3 is arranged in the extraction shaft 10. The entire horizontal well 5 is arranged below the groundwater table 19 of the aquifer 3. As a result, larger quantities of groundwater can be made available to the thermal power station from the aquifer 3 than with vertical wells known from the prior art. In this respect, it is possible to supply significantly more groundwater to the thermal power station and thus to extract significantly more heat energy, which can be made available to a plurality of heat customers A without having to increase the surface area requirement.

Filter pipes 2 are arranged within the extraction strings 6. In order to separate the groundwater to be pumped from particles, the filter pipes 2 lie in a bed, which can be formed from gravel 15 and/or glass balls 16 or similar filling material. In the present embodiment example, both gravel 15 and glass balls 16 are used as fill. However, this is only exemplary; in practice, each horizontal well 5 will be uniformly provided with a fill material, i.e. either gravel 15 or glass balls 16 or similar fill material, to accommodate the filter pipes 2. The use of glass balls 16 is recommended as they can be cleaned of particles more easily than gravel. Depending on the local geology, both the filter size of the filter pipes 2 and the grain size of the filling material can be adapted in order to avoid filling the filter pipes 2 with sand.

The groundwater from the aquifer 3 enters the filter line 2 located within the extraction string 6 via the fill of gravel 15 or glass balls 16 or similar filling material and is transferred to the primary line 17 of the thermal power station via the extraction line 7. To convey the groundwater from the aquifer 3 into the primary line 17, an extraction pump 20 is used in each extraction line 7. The extraction pumps 20 convey the groundwater within the extraction line 7 through the device at a pressure to be determined in each case in order to avoid or minimise precipitation or ochre formation within the extraction line 7 and injection line 9.

In the primary line 17, the groundwater is now fed to the heat power plant via the heat exchanger 13 and the heat pump 14 to extract the thermal energy contained in the groundwater. After the groundwater in the primary line 17 has passed the heat exchanger 13 and the heat pump 14, the now cooled groundwater is fed further via the primary line 17 to the injection section, in which it is returned to the aquifer 3.

In the present embodiment example, the injection section consists of an injection well 4, which is designed as an injection shaft 11 arranged below the earth's surface 21. Within this injection shaft 11, horizontal injection strings 8 are now also formed at different heights at an aquifer-side end 22 of the injection lines 9, in which in turn filter pipes 2 are arranged, which also lie in a fill of gravel 15 or glass balls 16. In this design example, the number of extraction strings 6 is equal to the number of injection strings 8, so that the same capacity level prevails on both sides of the geothermal doublet. All extraction strings 6 and injection strings 8 are the same length. Of course, it is also possible to increase the number of injection strings 8 or their length in order to increase the absorption capacity on the injection side so that the performance of the extraction pumps 20 in the extraction area is sufficient to return the groundwater to the aquifer 3.

The cooled groundwater is pumped into injection lines 9 via the primary line 17. Here, too, an injection pump not shown here can be used for delivery so that the cooled groundwater is returned to the aquifer 3 under pressure if the output of the extraction pumps 20 in the delivery area is not sufficient to return the groundwater to the aquifer 3.

The injection lines 9 feed the cooled groundwater into the filter pipes 2, which are stored in the horizontal injection strings 8, from where they feed the groundwater directly back into the aquifer 3.

Within the injection section, the filter pipes 2 and the injection strings 8 are also arranged at different heights within the injection shaft 11 and also the aquifer 3, so that the large amount of groundwater previously pumped from the aquifer 3 can also be easily made available to the aquifer 3 again. In this respect, the Injection strings 8 form a separate horizontal filter well 5′ analogue to the extraction strings 6.

As can be seen from the illustration in FIG. 1, the entire extraction of the groundwater in the extraction section and the return of the groundwater in the injection section takes place under the exclusion of external oxygen and external gas, so that the ochre formation problem is significantly minimised and the overall service life of the line system is significantly increased as a result. In principle, other or other technically known measures, such as the use of electrical potentials or—as already described—overpressure in the system, can also be used to minimise sedimentation of iron ochre in the line system of the geothermal doublet.

FIG. 2 shows a second example of a thermal power station according to the invention, in which a second example of a geothermal doublet according to the invention is used in a dry installation. The part of the thermal power station located above the earth's surface 21 corresponds to that of the embodiment example in FIG. 1, whereby a large number of consumers A are supplied with heat.

However, the part of the geothermal doublet below the earth's surface 21 differs in some details. It is true that the extraction section, like the embodiment example of FIG. 1, has a horizontal well 5 arranged in a extraction well1 formed as a vertical shaft 10 with four horizontal extraction strings 6 arranged at an aquifer-side end 12 of the extraction lines 7. However, in the embodiment example of FIG. 2, each individual extraction string 6 is connected to a separate extraction line 7, with all four extraction lines 7 flowing into the primary line 17 of the thermal power station. The entire horizontal well 5 is arranged below the groundwater table 19 of the aquifer 3.

Filter pipes 2 are also arranged within the extraction strings 6, which lie in a fill consisting of gravel 15 and/or glass balls 16 or similar filling material. In this embodiment example, both gravel 15 and glass balls 16 are also used as fill. However, this is only exemplary; in practice, each horizontal well 5 will be uniformly provided with a fill material, i.e. either gravel 15 or glass balls 16 or similar fill material, to accommodate the filter pipes 2.

The groundwater from the aquifer 3 enters the filter line 2 located within the extraction string 6 via the fill of gravel 15 or glass balls 16 or similar filling material and is transferred to the primary line 17 of the thermal power station via the extraction line 7. A separate extraction pump 20 is used in each of the four extraction lines 7 to convey the groundwater from the aquifer 3 into the primary line 17.

In the primary line 17, the groundwater is now fed, as in the embodiment example of FIG. 1, to the thermal power station via the heat exchanger 13 and the heat pump 14 to extract thermal energy contained in the groundwater. After the groundwater has passed the heat exchanger 13 and the heat pump 14 in the primary line 17, the now cooled groundwater is fed further via the primary line 17 to the injection section, in which it is returned to the aquifer 3.

In the present embodiment example, the injection section consists of an injection well 4, which is designed as an injection shaft 11 arranged below the earth's surface 21. Also within this injection shaft 11, four horizontal injection strings 8 are now formed at different heights at an aquifer-side end 22 of the injection lines 9, in which in turn filter pipes 2 are arranged, which also lie in a fill of gravel 15 or glass balls 16. In the present embodiment example, the number of extraction strings 6 is equal to the number of injection strings 8, so that the same capacity level prevails on both sides of the geothermal doublet, with each injection string 8 being connected to the primary line 17 via a separate injection line 9. In this embodiment example, all extraction strings 6 and injection strings 8 are also the same length. Of course, it is also possible to increase the number of injection strings 8 or their length in order to increase the absorption capacity on the injection side so that the output of the extraction pumps 20 in the delivery area is sufficient to return the groundwater to the aquifer 3. In this respect, the injection strings 8 form a separate horizontal filter well 5′ analogue to the extraction strings 6.

Here too, the cooled groundwater is pumped into injection lines 9 via the primary line 17. Here too, an injection pump not shown here can be used for pumping so that the cooled groundwater is returned to the aquifer 3 under pressure if the output of the extraction pumps 20 in the delivery area is not sufficient to return the groundwater to the aquifer 3.

As the design example in FIG. 2 also shows a closed dry installation of the geothermal doublet, this counteracts the problem of clogging of the line system, as in the design example in FIG. 1.

In contrast to the embodiment examples in FIGS. 1 and 2, the embodiment example in FIG. 3 shows a geothermal doublet in a wet installation. It is true that the part of the thermal power station located above the earth's surface 21 corresponds to that of the two embodiment examples described above, whereby a large number of consumers A are supplied with heat.

However, the part of the geothermal doublet located below the earth's surface 21 differs in some details. It is true that, like the embodiment examples described above, the extraction section has a horizontal well 5 arranged in an extraction well 1 formed as a vertical shaft 10 with four horizontal extraction strings 6 arranged at an aquifer-side end 12 of the extraction lines 7. However, in the embodiment example of FIG. 3, each individual extraction string 6 opens directly into the extraction shaft 10 in which the groundwater collects. The entire horizontal well 5 is also arranged here below the groundwater table 19 of the aquifer 3. Two extraction lines 7, each equipped with an extraction pump 20, dip into the groundwater collected in the extraction shaft 10 and convey the groundwater into a common primary line 17 of the thermal power station, from where it is fed back to an injection area. In this embodiment example, this is also designed as a wet installation and consists of an injection shaft 11 designed as an injection well 4. Four horizontal injection strings 8 are installed in the injection shaft 11, which flow directly into the injection shaft 11. Furthermore, two injection lines 9 lead from the primary line 17 into the injection shaft 11, into which the groundwater pumped by the extraction pumps 20 is taken, whereby the groundwater table 19 is also set here. The groundwater is fed back into the aquifer from the injection shaft 11 via the injection strings 8.

Both the extraction strings 6 and the injection strings 8 also have filter pipes 2 here, which lie in a fill that can be formed from gravel 15 and/or glass balls 16 or similar filling material. In the present embodiment example, both gravel 15 and glass balls 16 are used as fill. However, this is only exemplary; in practice, each horizontal well 5, 5′ will be uniformly provided with a fill material, i.e. either gravel 15 or glass balls 16 or similar fill material, in order to accommodate the filter pipes 2. The use of glass balls 16 is recommended, as these can be cleaned of particles more easily than gravel.

A wet installation of the geothermal doublet is generally suitable if the groundwater flowing in the aquifer 3 has a mineralisation that makes it unlikely that the line system of the geothermal doublet will be subject to sedimentation of iron ochre.

The systems shown in FIGS. 1 to 3 for extracting thermal energy from the aquifer 3 have been described here. However, it is also possible to use the system for cooling by introducing thermal energy into the aquifer 3 after the water extracted from the aquifer has been heated via the heat exchanger 13 or the heat pump 14.

### List of Reference Signs

1 Extraction well
2 Filter pipe
3 Aquifer
4 Injection well
5 Horizontal well
6 Extraction string
7 Extraction line
8 Injection string
9 Injection line
10 Extraction shaft
11 Injection shaft
12 Aquifer end
13 Heat exchanger
14 Heat pump
15 Gravel
16 Glass balls
17 Primary line
18 Secondary line
19 Groundwater table
20 Extraction pump
21 Ground surface
22 Aquifer end
A Heat customer

1-15. (canceled)

16. Device for exchanging geothermal energy with a near-surface aquifer for operation in a thermal power plant with an extraction well for pumping groundwater from the aquifer through at least one extraction line and an injection well for injecting the extracted groundwater into the aquifer through at least one injection line, wherein the at least one extraction line is connected to the at least one injection line for forwarding water via a primary line, wherein the extraction well has a plurality of horizontal extraction strings at its aquifer end, wherein the extraction strings are operatively connected to at least one extraction line for pumping water out of the aquifer and wherein a filter pipe is arranged within at least one extraction string, wherein the injection well has at least one horizontal injection string at its aquifer end, wherein:
the extraction well is designed as an extraction shaft and the injection well is designed as an injection shaft separate from and at a distance from the extraction shaft;
the at least one extraction line is arranged in the extraction shaft;
the at least one injection line is arranged in the injection shaft; and
a plurality of extraction strings are combined in a common extraction line.

17. Device according to claim 16, wherein:
the injection strings are operatively connected to at least one injection line for introducing water into the aquifer and wherein a filter pipe is arranged within each injection string.

18. Device according to claim 16, wherein:
the extraction well with the at least one extraction line and the at least one extraction string forms a first horizontal filter well; and
the injection well with the at least one injection line and the at least one injection string forms a second horizontal filter well.

19. Device according to claim 18, wherein:
the first and second horizontal filter wells form a geothermal doublet.

20. Device according to claim 16, wherein:
the device hast the same capacity on the extraction side and on the injection side for the extraction respectively injection of water or the device has on the injection side a greater capacity for the injection of water.

21. Device according to claim 16, wherein:
the groundwater extracted from the aquifer through the extraction well is con-veyed to the injection well with the exclusion of external oxygen.

22. Device according to claim 16, wherein:
the extraction well has at least two horizontal extraction strings, which are arranged at different heights of the extraction well within the aquifer.

23. Device according to claim 16, wherein:
the extraction well and the injection well have a minimum distance of ten times the depth of the extraction well and the injection well from one another.

24. Device according to claim 16, wherein:
at least one of:
the horizontal extraction strings have a length of greater than 10 meters; and
the horizontal injection strings have a length of greater than 10 meters.

25. Device according to claim 16, wherein:
at least one of:
the horizontal extraction strings have a length of greater than 50 meters; and
the horizontal injection strings have a length of greater than 50 meters.

26. Device according to claim 16, wherein:
at least one of:
the horizontal extraction strings have a length of greater than 100 meters; and
the horizontal injection strings have a length of greater than 100 meters.

27. Device according to claim 16, wherein:
the filter pipes are supported in a bed, gravel or glass balls being used as bedding material.

28. Device according to claim 16, wherein:
the filter pipes are supported in a bed, gravel or glass balls being used as filter material.

29. Device according to claim 16, wherein:
feed pumps are arranged for conveying the water within the extraction well.

30. Device according to claim 29, wherein:
the water is pumped through the at least one extraction line and the at least one injection line at a pressure to be determined or adapted.

31. Thermal power plant with at least one device according to claim 16.

32. Thermal power plant according to claim 31, further comprising:
at least one of:
at least one heat exchanger configured to extract or supply thermal energy to the groundwater pumped between the extraction well and the injection well; and
at least one heat pump configured to extract or supply thermal energy to the groundwater pumped between the extraction well and the injection well.

33. Thermal power plant according to claim 31, further comprising:
at least one of:
at least one heat exchanger configured to extract or supply thermal energy to the groundwater pumped between the extraction well and the injection well, the at least one heat exchanger operatively connected on the one hand to the primary line and on the other hand to a closed secondary line for the transfer of thermal energy, the secondary line being operatively connected to heat customers; and
at least one heat pump configured to extract or supply thermal energy to the groundwater pumped between the extraction well and the injection well, the at least one heat pump operatively connected on the one hand to the primary line and on the other hand to a closed secondary line for the transfer of thermal energy, the secondary line being operatively connected to heat customers.
